(19) United States
(12) Patent Application Publication
(10) Pub. No.: US 2016/0223455 A1
(43) Pub. Date: Aug. 4, 2016

(54) CONTAINER, EVALUATING METHOD, AND CONTAINER TYPE DATA CENTER

(71) Applicant: FUJITSU LIMITED, Kawasaki-shi (JP)

(72) Inventor: Akira MINEGISHI, Setagaya (JP)

(73) Assignee: FUJITSU LIMITED, Kawasaki-shi (JP)

(21) Appl. No.: 14/959,970

(22) Filed: Dec. 4, 2015

(30) Foreign Application Priority Data
Jan. 30, 2015 (JP) 2015-017397

(51) Int. Cl. G01N 19/10; F24F 11/00

(52) U.S. Cl. CPC G01N 19/10; F24F 11/0008

(57) ABSTRACT

A container includes: a humidifier configured to humidify a room to a given humidity; a measuring instrument configured to measure humidity of the room for a fixed time from a point in time that the room is humidified to the given humidity; and an information processing device configured to obtain an opening area of the room based on an amount of decrease in absolute humidity in the fixed time.

### CROSS-REFERENCE TO RELATED APPLICATION

This application is based upon and claims the benefit of priority of the prior Japanese Patent Application No. 2015-017397, filed on Jan. 30, 2015, the entire contents of which are incorporated herein by reference.

### FIELD

The embodiment discussed herein is related to a container, an evaluating method, and a container type data center.

### BACKGROUND

A data center is a facility that manages information and communications technology (ICT) devices or the like. A data center is a facility that includes a high-speed communication line, electric power generating equipment, and air conditioning equipment and which can perform centralized management of ICT devices including a plurality of servers.

A related technology is disclosed in Japanese Laid-open Patent Publication No. 05-296530 or Japanese Laid-open Patent Publication No. 2003-240666.

### SUMMARY

According to one aspect of the embodiments, a container includes: a humidifier configured to humidify a room to a given humidity; a measuring instrument configured to measure humidity of the room for a fixed time from a point in time that the room is humidified to the given humidity; and an information processing device configured to obtain an opening area of the room based on an amount of decrease in absolute humidity in the fixed time.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 illustrates an example of a container type data center;

FIG. 2 illustrates an example of a functional configuration of an information processing device;

FIG. 3 illustrates an example of hardware configuration of an information processing device;

FIG. 4 illustrates an example of temperatures and absolute humidities;

FIG. 5 illustrates an example of opening area information;

FIG. 6 illustrates an example of processing of an information processing device;

FIGS. 7A to 7C illustrate an example of a container type data center;

FIG. 8 illustrates an example of a method of identifying equipment having poor airtightness;

FIG. 9 illustrates an example of test result information; and

FIGS. 10A and 10B illustrate an example of processing of identifying equipment having poor airtightness.

### DESCRIPTION OF EMBODIMENT

A container type data center is provided as a data center using natural energy. The container type data center includes a container and an air conditioner. The air conditioner is disposed outside the container to cool the inside of the data center. Methods by which the air conditioner cools the inside of the data center include an indirect outside air cooling system that cools an air within a chamber by heat exchange using an outside air temperature. The container type data center reduces an amount of power consumed by the air conditioner by cooling the data center using an outside air.

As an example, a device controls the air pressure and ventilation of an air-conditioned environment, tests and measures airtightness, and has a warning function.

Quantities corresponding to absolute humidities inside and outside a sealed casing are obtained by using output signals of temperature sensors and humidity sensors arranged inside and outside the sealing casing, respectively. A degradation in airtightness is detected by outputting an alarm signal based on result of comparison between the quantities corresponding to the two absolute humidities.

When a harmful gas enters the inside of the container type data center, ICT devices or the like may be corroded. For operation of the ICT devices, it is desirable to maintain a substantially uniform airtightness within the container.

After the container type data center is assembled at an installation site, the airtightness of the container is measured. Depending on the installation site, the preparation, setting, and the like of a compression pump or a barometer that measures the airtightness of the container may be difficult. Therefore airtightness measurement may not be performed easily.

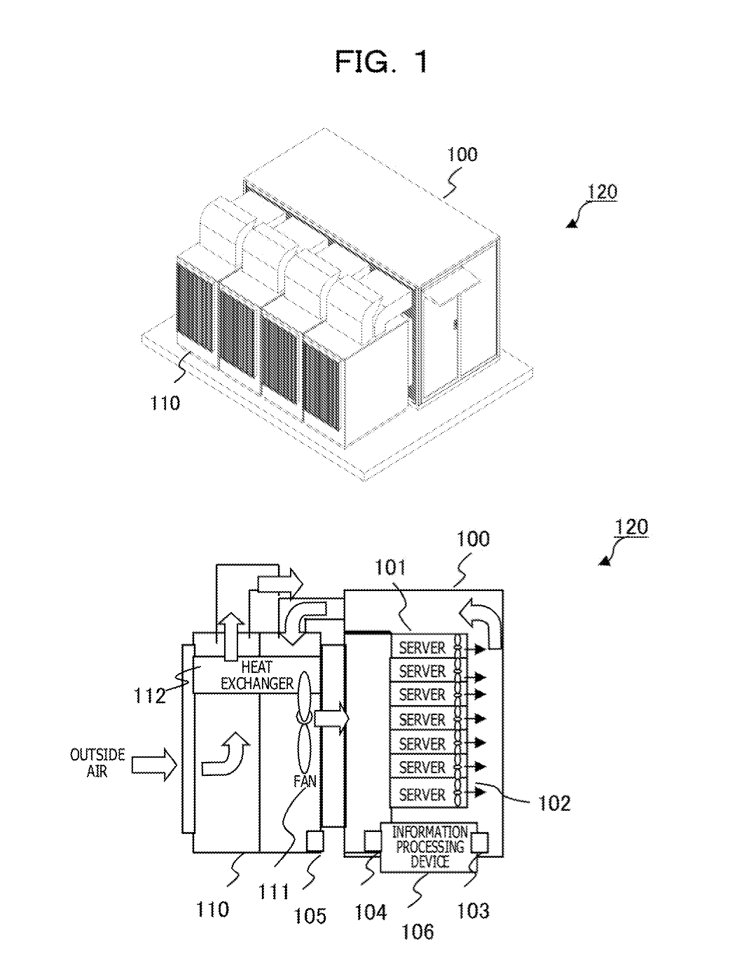

FIG. 1 illustrates an example of a container type data center. A container type data center 120 of FIG. 1 includes a container 100 and an air conditioner 110. The container 100 includes a server rack 102. The server rack 102 houses a plurality of servers 101. The air conditioner 110 is disposed outside the container 100 to cool the inside of the container 100. As a method by which the air conditioner 110 cools the inside of the container 100, an indirect outside air cooling system may be adopted which cools an air within a chamber by heat exchange using an outside air temperature. In the container type data center 120, an amount of power consumed by the air conditioner 110 may be reduced by cooling the container 100 using an outside air.

The container type data center 120 of FIG. 1 adopts the indirect outside air cooling system. As a system structure, the air conditioner 110 includes a fan 111 and a heat exchanger 112. The container type data center 120 adopting the indirect outside air cooling system includes the fan 111 as a cooler so as to face the server rack 102. Because the fan 111 is installed so as to face the server rack 102, the fan 111 directly feeds a cool air to the servers 101, and uniformly cools each of the servers 101. The heat exchanger 112 cools the air within the container 100 using the outside air temperature. The heat exchanger 112 cools the air within the container 100 using the outside air and the outside air temperature so that the temperature of the air within the container 100 becomes a set temperature. The heat exchanger 112 may include a compressor. When the outside air temperature is high, the heat exchanger 112 cools the air using the compressor.

The container 100 includes a thermo-hygrometer 103, a humidifier 104, and an information processing device 106 that transmits control instructions. The air conditioner 110 includes a thermo-hygrometer 105. The thermo-hygrometer 103 may be an appliance that measures humidity and temperature within the container 100. The humidifier 104 may be a device that humidifies the air within the container 100 by using a water vapor. The humidification of the humidifier 104 may be performed within a range allowed based on the specifications of ICT devices, for example a range in which the ICT devices are not adversely affected. The humidifier 104 is controlled by the information processing device 106. The thermo-hygrometer 105 may be an appliance that measures humidity and temperature outside the container 100. The example of FIG. 1 does not limit installation sites of the various kinds of devices installed within the container type data center 120.

The information processing device 106 is coupled to the various kinds of devices within the container 100 and the air conditioner 110 via a communication channel (bus). For example, the information processing device 106 is coupled to each server via the communication channel, and obtains information on power consumption of the servers 101. The information processing device 106 obtains environmental information such as temperature and humidity inside and outside the container 100 from the thermo-hygrometer 103 and the thermo-hygrometer 105. The information processing device 106 is also coupled to the humidifier 104 via the communication channel.

The container type data center 120 is assembled at an installation site. The information processing device 106 performs processing of determining the airtightness of the container 100 from the environmental information based on a result of humidification. An opening area of the container 100 is obtained from a result of measurement of the various kinds of devices. The opening area refers to an area through which the air can pass from the inside of the container 100 to the outside of the container 100 or from the outside of the container 100 to the inside of the container 100. The opening area is for example the area of a gap present in a boundary surface between a non-airtight external space and a highly airtight internal space. The following (1) to (7) illustrate a procedure that determines airtightness. The processing of (1) to (7) may hereinafter be referred to as airtightness determination processing.

(1) The information processing device 106 controls the humidifier 104 to humidify the inside of the container 100. The humidifier 104 humidifies the inside of the container 100 so as to make relative humidity within the container 100 sufficiently high.

(2) The thermo-hygrometer 103 measures the relative humidity within the container 100. The information processing device 106 obtains a result of the measurement from the thermo-hygrometer 103. The processing of (2) may be performed in parallel with the processing of (1).

(3) When the relative humidity within the container 100 reaches a given threshold value, the information processing device 106 transmits an instruction to stop the humidification to the humidifier 104. The humidifier 104 stops the humidification.

(4) The thermo-hygrometer 103 measures the relative humidity within the container 100 for a fixed time after the relative humidity within the container 100 reaches the given threshold value. The information processing device 106 obtains a result of the measurement from the thermo-hygrometer 103.

(5) The information processing device 106 calculates an amount of decrease in absolute humidity within the container 100 in the period of the fixed time from the time point of the stop of the humidification by the humidifier 104 in (3).

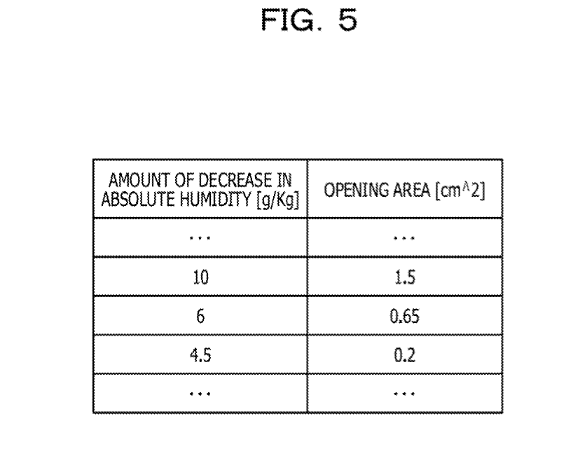

(6) The information processing device 106 estimates the opening area of the container 100 on the basis of opening area information (for example information illustrated in FIG. 5) associating the amount of decrease in the absolute humidity as a result of the calculation with the opening area.

(7) The information processing device 106 determines that there is a problem with the airtightness of the container 100 when the opening area is equal to or more than a given value. When the opening area is equal to or more than the given value, the information processing device 106 may perform error display on a monitor or the like.

In a case where airtightness within the container is measured directly, it may be difficult to prepare and set a compression pump, a barometer, and the like. For example, the equipment such as the humidifier and the thermo-hygrometers described above may be low in cost and easy to set. The container type data center 120 may easily estimate and determine the airtightness by using the humidifier and the thermo-hygrometers described above.

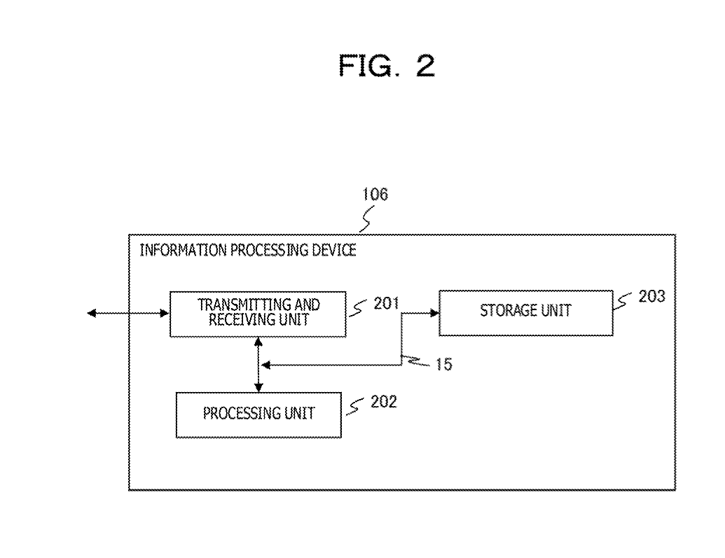

FIG. 2 illustrates an example of a functional configuration of an information processing device. The information processing device 106 includes a transmitting and receiving unit 201, a processing unit 202, and a storage unit 203. The transmitting and receiving unit 201, the processing unit 202, and the storage unit 203 are coupled to each other by a bus 15. The storage unit 203 stores opening area information associating the amount of decrease in the absolute humidity in the period of the fixed time from the time point of the stop of the humidification by the humidifier 104 in (3) with the opening area. The transmitting and receiving unit 201 is a communication interface. The transmitting and receiving unit 201 obtains humidity, temperature, and equipment state information from the thermo-hygrometers 103 and 105 and the air conditioner 110 based on an instruction from the processing unit 202. The transmitting and receiving unit 201 sends an instruction to control the humidifier 104 based on an instruction from the processing unit 202.

The processing unit 202 sends the instruction to control the humidifier 104 to the transmitting and receiving unit 201. For example, when the processing unit 202 determines airtightness within the container 100, the processing unit 202 makes the humidifier 104 operate until the relative humidity within the container 100 reaches a given threshold value. For example, the processing of (1) to (3) is performed. The processing unit 202 calculates an amount of decrease in the absolute humidity within the container 100 in the period of the fixed time from the point in time that the humidifier 104 is stopped. For example, the processing of (5) is performed. The processing unit 202 estimates the opening area of the container 100 based on the opening area information associating the amount of decrease in the absolute humidity with the opening area. For example, the processing of (6) is performed. When the opening area is equal to or more than a given value, the processing unit 202 determines that there is a problem with the airtightness of the container 100. For example, the processing of (7) is performed.

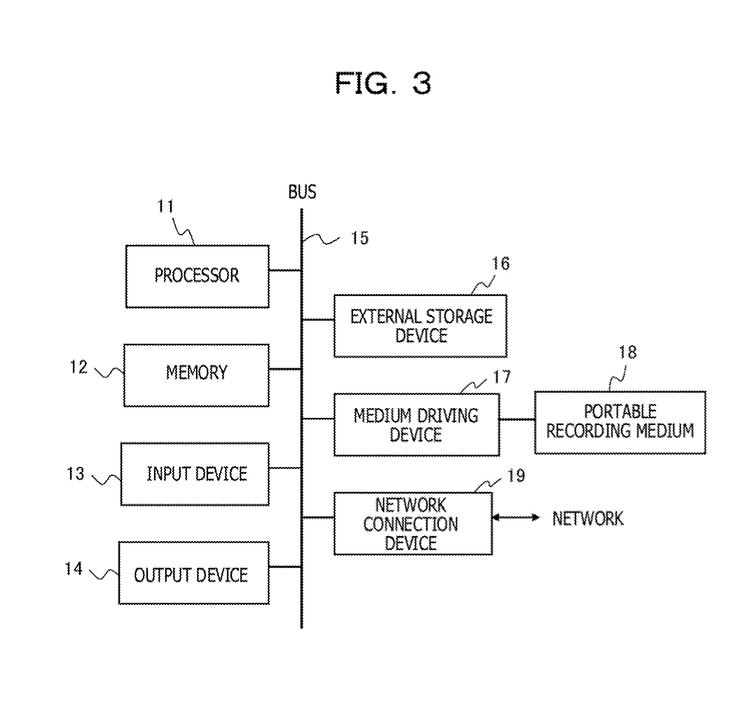

FIG. 3 illustrates an example of hardware configuration of an information processing device. The information processing device 106 includes a processor 11, a memory 12, the bus 15, an external storage device 16, and a network connection device 19. The information processing device 106 may include an input device 13, an output device 14, and a medium driving device 17. The information processing device 106 may be for example a computer or the like.

The processor 11 may be an arbitrary processing circuit including a central processing unit (CPU). In the information processing device 106, the processor 11 may operate as the processing unit 202. The processor 11 for example executes a program stored in the external storage device 16. The memory 12 operates as the storage unit 203. The memory 12 retains the opening area information associating the amount of decrease in the absolute humidity with the opening area. The memory 12 may store data obtained by the operation of the processor 11 and data used for the processing of the processor 11 as appropriate. The network connection device 19 is used for communication with another device. As illustrated in FIG. 2, the bus 15 is a communication channel coupled to the transmitting and receiving unit 201.

The input device 13 may be for example a button, a keyboard, a mouse, or the like. The output device 14 may be a display or the like. The bus 15 establishes coupling between the processor 11, the memory 12, the input device 13, the output device 14, the external storage device 16, the medium driving device 17, and the network connection device 19 so that data can be mutually transferred therebetween. The external storage device 16 stores a program, data, and the like. The external storage device 16 may be for example a hard disk drive (HDD) or a solid-state drive (SSD). The information stored in the external storage device 16 may be provided to the processor 11 and the like as appropriate. The medium driving device 17 may output data stored in the memory 12 and the external storage device 16 to a portable recording medium 18, and read a program, data, and the like from the portable recording medium 18. The portable recording medium 18 may be an arbitrary portable storage medium such as a floppy disk, a magneto-optical (MO) disk, a compact disc recordable (CD-R) or a digital versatile disc recordable (DVD-R). The portable recording medium 18 may be a semiconductor memory card such as a flash memory or the like, and the medium driving device 17 may be a reader and writer for the memory card. The memory 12, the external storage device 16, and the portable recording medium 18 may each be an example of a tangible storage medium.

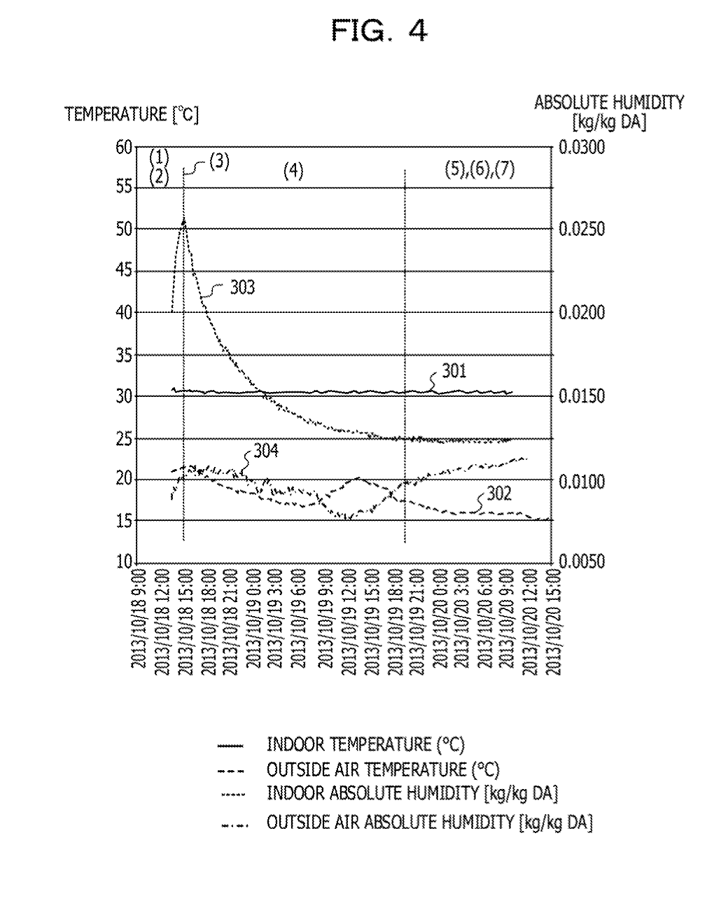

FIG. 4 illustrates an example of temperatures and absolute humidities. FIG. 4 illustrates an indoor temperature 301, an outside air temperature 302, an indoor absolute humidity 303, and an outside air absolute humidity 304. In FIG. 4, an axis of abscissas indicates time, an axis of ordinates (left) indicates temperature, and an axis of ordinates (right) indicates absolute humidity. The temperature on the axis of ordinates (left) is indicated in units of ° C. The temperature indicated by the axis of ordinates (left) is used to represent the indoor temperature 301 and the outside air temperature 302. The absolute humidity on the axis of ordinates (right) is indicated in units of [kg/kg (dry air (DA))]. The absolute humidity on the axis of ordinates (right) is used to represent the indoor absolute humidity 303 and the outside air absolute humidity 304. The term “indoor” refers to the inside of the container 100.

The indoor temperature 301 is information indicating room temperature within the container 100 which is measured by the thermo-hygrometer 103. The outside air temperature 302 is information indicating atmospheric temperature outside the container 100 which is measured by the thermo-hygrometer 105. The indoor absolute humidity 303 is calculated by the information processing device 106 using the relative humidity and the indoor temperature 301 measured by the thermo-hygrometer 103. The outside air absolute humidity 304 is calculated by the information processing device 106 using the relative humidity and the outside air temperature 302 measured by the thermo-hygrometer 105.

When the information processing device 106 performs the processing of (1), the indoor absolute humidity 303 rises as illustrated in FIG. 4. When the indoor absolute humidity 303 reaches a given threshold value (dotted line part of (3)), the information processing device 106 stops the humidifier 104. The thermo-hygrometer 103 thereafter measures the relative humidity within the container 100 for a fixed time (time (4) between two dotted lines), and sends measurement information to the information processing device 106.

When the fixed time has passed since the stopping of the humidifier 104, a value representing the indoor absolute humidity 303 approaches a value representing the outside air absolute humidity 304. The absolute humidities are calculated by the information processing device 106 using the relative humidities, the room temperature, and the outside air temperature. It is understood that the shorter a time in which the value representing the indoor absolute humidity 303 approaches the value representing the outside air absolute humidity 304, the larger the opening area of the container 100. The longer the time in which the value representing the indoor absolute humidity 303 approaches the value representing the outside air absolute humidity 304, the smaller the opening area of the container 100. As an example, the magnitude of the opening area corresponding to an amount of decrease in the indoor absolute humidity 303 (difference in the indoor absolute humidity 303 between the two dotted lines) in the period of the fixed time from the stopping of the humidifier 104 may be estimated based on experimental data.

FIG. 5 illustrates an example of opening area information. The opening area information may be information associating the amount of decrease in the absolute humidity with the opening area. The opening area information includes the amount of decrease [g/Kg] in the absolute humidity and the opening area [cm²] corresponding to the amount of decrease in the absolute humidity. The amount of decrease in the absolute humidity is an amount of decrease in the absolute humidity within the container 100 in the period of the fixed time after the relative humidity within the container 100 reaches the given threshold value (after the processing of (3)). The opening area is an area that corresponds to the amount of decrease in the absolute humidity within the container 100 in the period of the fixed time and through which an air can pass from the inside of the container 100 to the outside of the container 100 or from the outside of the container 100 to the inside of the container 100. For example, the opening area is an area representing a gap in the container 100.

The opening area information illustrated in FIG. 5 may be generated in advance based on experimental data, for example. The opening area information associating the amount of decrease in the absolute humidity with the opening area may be changed depending on for example the size of the container 100.

In FIG. 5, for example, when the amount of decrease in the absolute humidity is 10 [g/Kg], the opening area is 1.5 [cm²]. In FIG. 5, for example, when the amount of decrease in the absolute humidity is 6 [g/Kg], the opening area is 0.65 [cm²]. In FIG. 5, for example, when the amount of decrease in the absolute humidity is 4.5 [g/Kg], the opening area is 0.2 [cm²]. Thus, the larger the amount of decrease in the absolute humidity in the period of the fixed time from the stopping of the humidifier 104, the larger the opening area of the container 100.

The opening area information of FIG. 5 assumes a container having a wall thickness L and a hole (opening portion) in one part, and may be generated by using Equation (1).

dPₑ/dt=−K(α/1)(Pₑ−P) Equation (1)

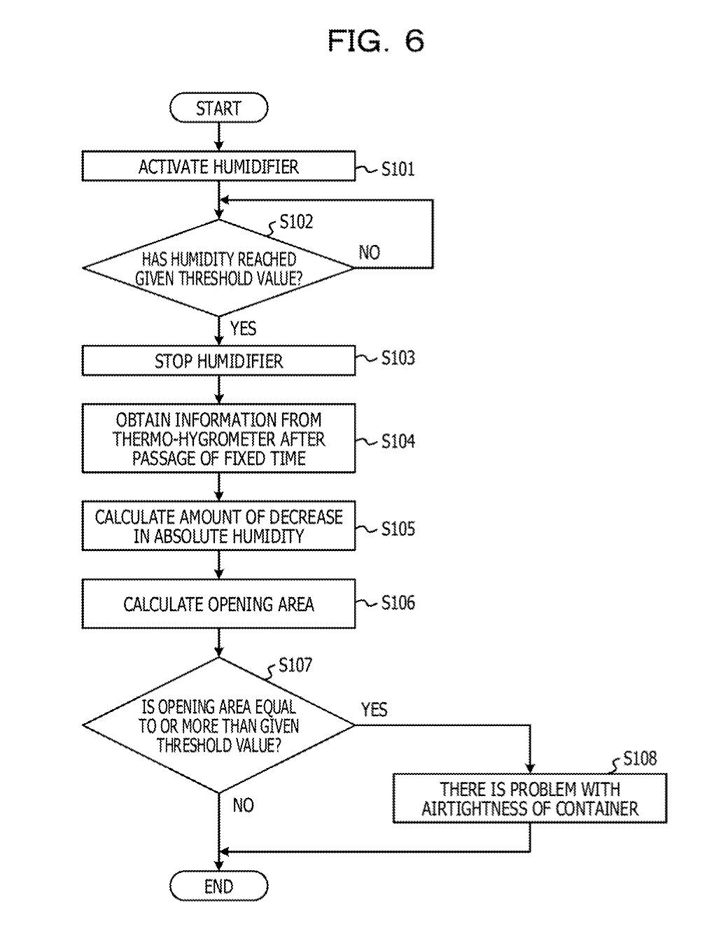

In Equation (1), Pₑ denotes an internal water vapor density, K denotes the diffusion coefficient of water vapor, α denotes an effective opening area, and P denotes external water vapor density. The effective opening area is calculated by a fitting method between experimental numerical values and the integral curve of Equation (1). Thus, Equation (1) may be used to generate the opening area information. FIG. 6 illustrates an example of processing of an information processing device. The processing unit 202 of the information processing device 106 activates the humidifier 104 (operation S101). The processing unit 202 of the information processing device 106 obtains a result of measurement from the thermo-hygrometer 103, and determines whether the relative humidity within the container 100 has reached a given threshold value (operation S102). When the relative humidity within the container 100 has not reached the given threshold value (NO in operation S102), the processing unit 202 repeats the processing of operation S102.

When the relative humidity within the container 100 has reached the given threshold value (YES in operation S102), the processing unit 202 stops the humidification of the humidifier 104 (operation S103). The processing unit 202 obtains a result of measurement from the thermo-hygrometer 103 after the passage of the fixed time from operation S103 (operation S104). The processing unit 202 calculates an amount of decrease in the absolute humidity within the fixed time from the measurement results (operation S105). The processing unit 202 calculates an opening area corresponding to the amount of decrease in the absolute humidity by using the opening area information stored in the storage unit 203 (operation S106). The processing unit 202 determines whether the opening area is equal to or more than a given threshold value (operation S107). When the opening area is equal to or more than the given threshold value (YES in operation S107), the processing unit 202 determines that there is a problem with the airtightness of the container 100, and performs error display on a monitor or the like (operation S108). When the opening area is smaller than the given threshold value (NO in operation S107), the processing unit 202 ends the processing.

The equipment such as the humidifier and the thermo-hygrometers is low in cost and easy to set. Therefore, in the container type data center 120, airtightness may be estimated easily by using the humidifier and the thermo-hygrometers.

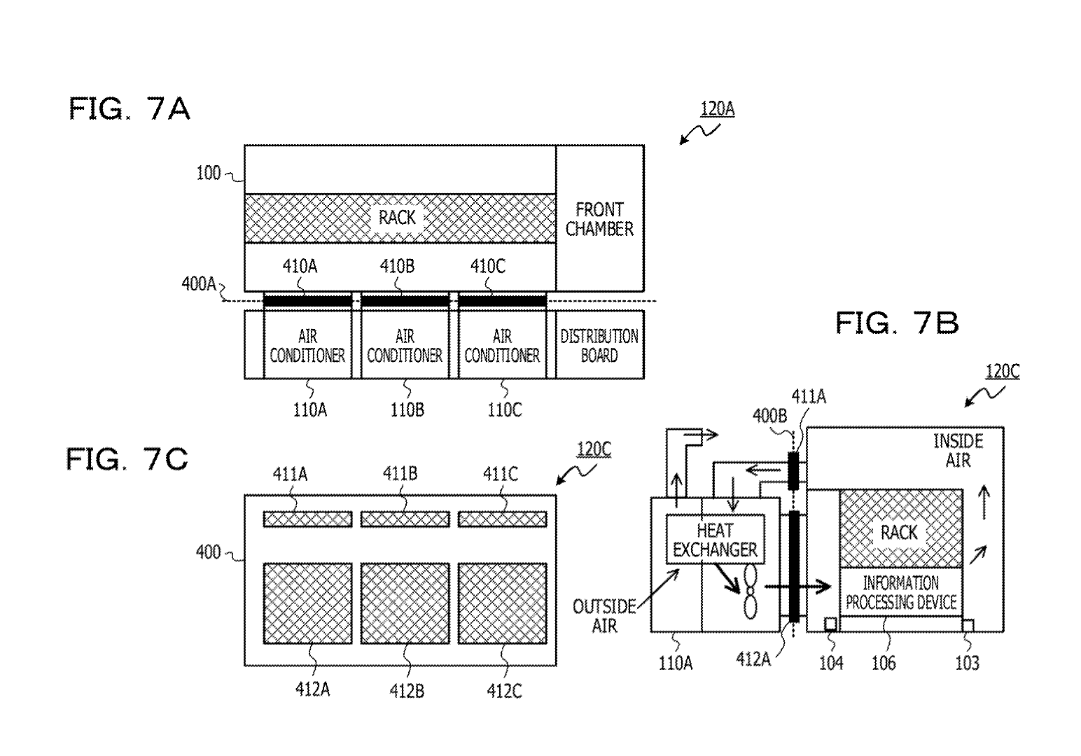

FIGS. 7A to 7C illustrate an example of a container type data center. FIGS. 7A to 7C illustrate a container type data center that identifies equipment having poor airtightness. In the container type data center 120 of FIGS. 7A to 7C, elements substantially identical or similar to those of FIG. 1 may be identified by the same reference numerals, and description thereof may be omitted. A container type data center 120A illustrated in FIG. 7A is a sectional view of the container type data center 120 as viewed in plan. A container type data center 120B illustrated in FIG. 7B is a sectional view of the container type data center 120 as viewed from a side surface. The container type data center 120 includes a ventilating hole 411 and a ventilating hole 412 that couple the air conditioner 110 and the container 100 to each other. A container type data center 120C illustrated in FIG. 7C is a sectional view of the ventilating hole 411 and the ventilating hole 412 taken along a dotted line 400A of the container type data center 120A and a dotted line 400B of the container type data center 120B.

The container type data center 120 includes three air conditioners 110 (110A to 110C). The container type data center 120 includes lids 410A to 410C. The lid 410A closes a ventilating hole 412A as a feeding port of an air fed by an air conditioner 110A to cool the inside of the container 100 and a ventilating hole 411A as an intake port that takes in the air after the cooling from the container 100. The lid 410B closes a ventilating hole 412B as a feeding port of an air fed by an air conditioner 110B to cool the inside of the container 100 and a ventilating hole 411B as an intake port that takes in the air after the cooling from the container 100. The lid 410C closes a ventilating hole 412C as a feeding port of an air fed by an air conditioner 110C to cool the inside of the container 100 and a ventilating hole 411C as an intake port that takes in the air after the cooling from the container 100. The opening and closing of the lids 410A to 410C may be controlled by the information processing device 106. The lids 410 may be lids that do not allow the air to pass through, and the lids 410 may not include an opening portion. The air conditioners 110A to 110C may include an opening portion.

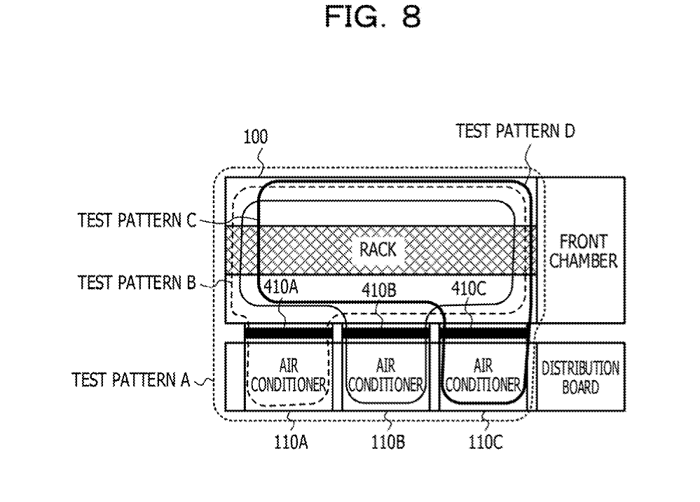

FIG. 8 illustrates an example of a method of identifying equipment having poor airtightness. In the container type data center 120 of FIG. 8, elements substantially identical or similar to those of FIGS. 7A to 7C may be identified by the same reference symbols, and description thereof may be omitted. Equipment having poor airtightness may be identified by repeating the processing of the above-described airtightness (estimation) determination (1) to (7) in a plurality of test patterns in which the lids 410A to 410C are opened or closed. The airtightness determination processing is performed in the following test patterns in the container type data center 120 including the air conditioners 110A to 110C.

Test pattern A: the air conditioner 110A (without the lid), the air conditioner 110B (without the lid), and the air conditioner 110C (without the lid)

Test pattern B: the air conditioner 110A (without the lid), the air conditioner 110B (with the lid), and the air conditioner 110C (with the lid)

Test pattern C: the air conditioner 110A (with the lid), the air conditioner 110B (without the lid), and the air conditioner 110C (with the lid)

Test pattern D: the air conditioner 110A (with the lid), the air conditioner 110B (with the lid), and the air conditioner 110C (without the lid)

“With the lid” indicates that the ventilating hole 411 and the ventilating hole 412 are closed by closing the lid 410. “Without the lid” indicates a state in which the lid of the air conditioner 110 is opened by control of the information processing device 106 and the air conditioner 110 is operating. The information processing device 106 controls the opening and closing of the lids 410A to 410C so that the settings of the test patterns A to D are made, and performs the airtightness determination processing in each of the test patterns A to D.

The equipment whose airtightness is to be determined in the test pattern A is the air conditioners 110A to 110C and the container 100. The equipment whose airtightness is to be determined in the test pattern B is the air conditioner 110A and the container 100. The equipment whose airtightness is to be determined in the test pattern C is the air conditioner 110B and the container 100. The equipment whose airtightness is to be determined in the test pattern D is the air conditioner 110C and the container 100. The information processing device 106 stores, in advance, information on the test patterns representing patterns in which the lids 410A to 410C are opened or closed. The information on the test patterns is stored in the storage unit 203. In FIG. 8, the number of air conditioners 110 is three, and therefore four test patterns are provided. When the number of air conditioners 110 is N, the number of test patterns is N+1.

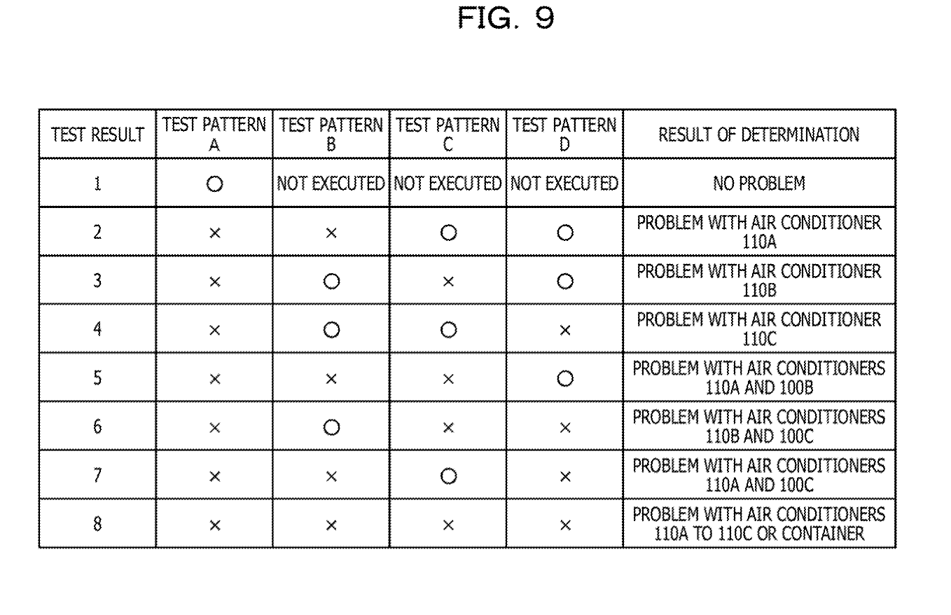

FIG. 9 illustrates an example of test result information. The information processing device 106 identifies equipment having poor airtightness based on test results in the test patterns A to D and the test result information. The test result information may be stored in the storage unit 203. In the processing of identifying equipment having poor airtightness, the information processing device 106 performs the airtightness determination processing in the test pattern A. When an opening area calculated as a result of performing the airtightness determination processing in the test pattern A is smaller than a given value, there is no problem with the airtightness of the air conditioners 110A to 110C and the container 100.

The result of the test pattern A indicates that there is no problem with the airtightness of the air conditioners 110A to 110C and the container 100, and therefore the other test patterns B to D are not executed. The information processing device 106 refers to a test result 1 having “∘” indicating that there is no problem with airtightness as the test result of the test pattern A, and determines that there is no problem with the airtightness of the air conditioners 110A to 110C and the container 100.

When the opening area calculated as the result of performing the airtightness determination processing in the test pattern A is equal to or larger than the given value, the information processing device 106 performs the airtightness determination processing in the test patterns B to D. When three tests are executed in the test patterns B to D, a test result is one of test results 2 to 8.

The test result 2 is an example in which it is determined as a result of determination in the test pattern B that there is a problem with airtightness and it is determined as test results of the test patterns C and D that there is no problem with airtightness. In the test result 2 of FIG. 9, “x” denotes that there is a problem with airtightness as a result of determination in the test pattern B. Equipment that may have a problem with airtightness in the result of the test pattern B is the air conditioner 110A, the container 100, or both thereof. In the test pattern C and the test pattern D, the container 100 is an object for determination and it is determined that the container 100 has no problem with airtightness. The container 100 therefore has no problem with airtightness. Then, when the results of execution in the test patterns B to D are the test result 2, the information processing device 106 determines that there is a problem with the air conditioner 110A. The information processing device 106 notifies an administrator of information on the equipment having a problem with airtightness.

The test result 3 is an example in which it is determined as a result of determination in the test pattern C that there is a problem with airtightness and it is determined as test results of the test patterns B and D that there is no problem with airtightness. Equipment that may have a problem with airtightness in the result of the test pattern C is the air conditioner 110B, the container 100, or both thereof. In the test pattern B and the test pattern D, the container 100 is an object for determination and it is determined that the container 100 has no problem with airtightness. The container 100 therefore has no problem with airtightness. When the results of execution in the test patterns B to D are the test result 3, the information processing device 106 determines that there is a problem with the air conditioner 110B. The information processing device 106 notifies the administrator of information on the equipment having a problem with airtightness.

The test result 4 is an example in which it is determined as a result of determination in the test pattern D that there is a problem with airtightness and it is determined as test results of the test patterns B and C that there is no problem with airtightness. Equipment that may have a problem with airtightness in the result of the test pattern D is the air conditioner 110C, the container 100, or both thereof. In the test pattern B and the test pattern C, the container 100 is an object for determination and it is determined that there is no problem with airtightness. The container 100 therefore has no problem with airtightness. When the results of execution in the test patterns B to D are the test result 4, the information processing device 106 determines that there is a problem with the air conditioner 110C. The information processing device 106 notifies the administrator of information on the equipment having a problem with airtightness.

The test result 5 is an example in which it is determined as results of determination in the test pattern B and the test pattern C that there is a problem with airtightness and it is determined as a test result of the test pattern D that there is no problem with airtightness. Equipment that may have a problem with airtightness in the results of the test pattern B and the test pattern C is the air conditioner 110A, the air conditioner 110B, the container 100, or all thereof. In the test pattern D, the container 100 is an object for determination and it is determined that the container 100 has no problem with airtightness. The container 100 therefore has no problem with airtightness. When the results of execution in the test patterns B to D are the test result 5, the information processing device 106 determines that there is a problem with the air conditioner 110A and the air conditioner 110B. The information processing device 106 notifies the administrator of information on the equipment having a problem with airtightness.

The test result 6 is an example in which it is determined as results of determination in the test pattern C and the test pattern D that there is a problem with airtightness and it is determined as a test result of the test pattern B that there is no problem with airtightness. Equipment that may have a problem with airtightness in the results of the test pattern C and the test pattern D is the air conditioner 110B, the air conditioner 110C, the container 100, or all thereof. In the test pattern B, the container 100 is an object for determination and it is determined that there is no problem with airtightness. The container 100 therefore has no problem with airtightness. When the results of execution in the test patterns B to D are the test result 6, the information processing device 106 determines that there is a problem with the air conditioner 110B and the air conditioner 110C. The information processing device 106 notifies the administrator of information on the equipment having a problem with airtightness.

The test result 7 is an example in which it is determined as results of determination in the test pattern B and the test pattern D that there is a problem with airtightness and it is determined as a test result of the test pattern C that there is no problem with airtightness. Equipment that may have a problem with airtightness in the results of the test pattern B and the test pattern D is the air conditioner 110A, the air conditioner 110C, the container 100, or all thereof. In the test pattern C, the container 100 is an object for determination and it is determined that there is no problem with airtightness. The container 100 therefore has no problem with airtightness. When the results of execution in the test patterns B to D are the test result 7, the information processing device 106 determines that there is a problem with the air conditioner 110A and the air conditioner 110C. The information processing device 106 notifies the administrator of information on the equipment having a problem with airtightness.

The test result 8 is an example in which it is determined as results of determination in the test patterns B to D that there is a problem with airtightness. Equipment that may have a problem with airtightness in the results of the test patterns B to D is all of the equipment such as the air conditioner 110A, the air conditioner 110B, the air conditioner 110C, and the container 100. When the results of execution in the test patterns B to D are the test result 8, the information processing device 106 determines that there is a problem with the airtightness of all of the air conditioners 110A to 110C, or determines that there is a problem with the airtightness of the container 100. The information processing device 106 notifies the administrator of information on the equipment having a problem with airtightness.

The information processing device 106 thus makes the air conditioners 110A to 110C operate one by one and determines airtightness in each of the test patterns. It is thereby determined that one or a part or all of the air conditioners 110A to 110C or the container 100 has a problem with airtightness.

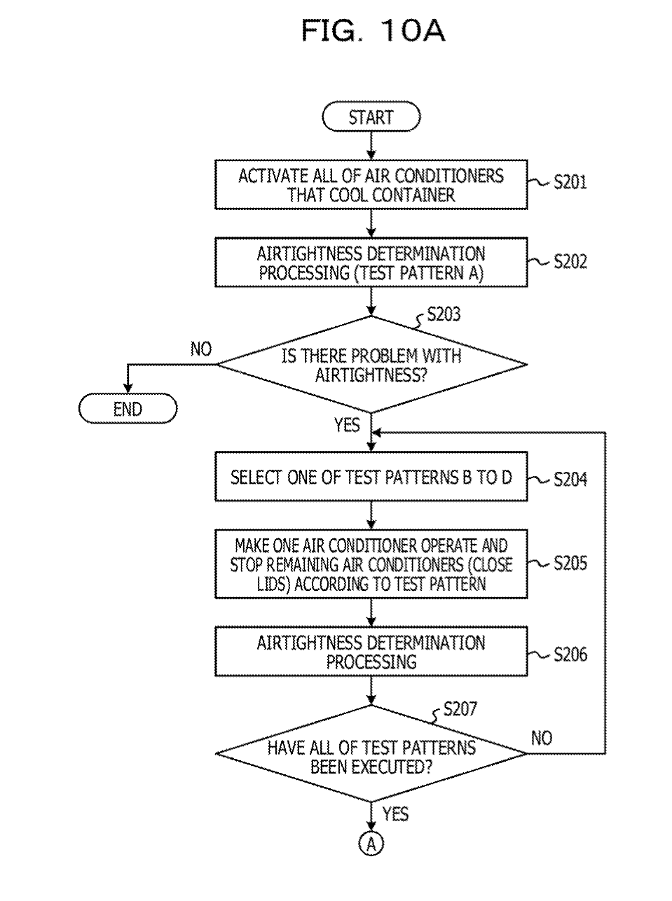

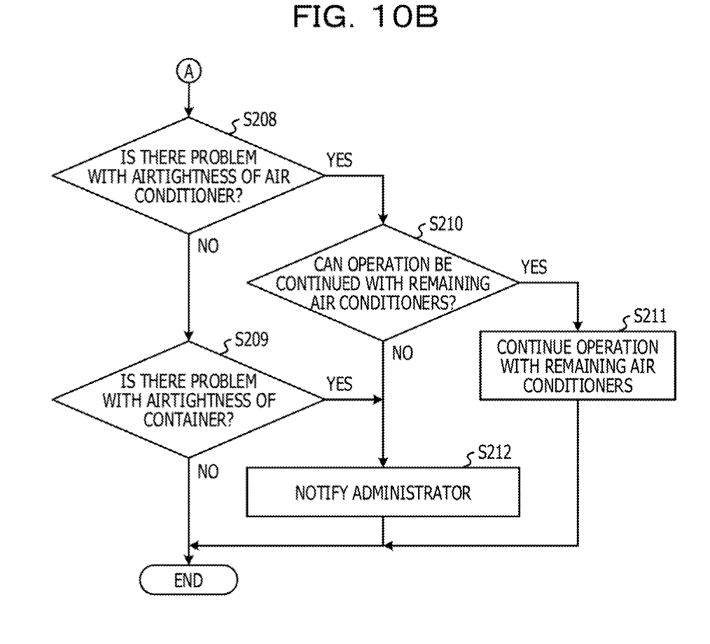

FIGS. 10A and 10B illustrate an example of processing of identifying equipment having poor airtightness. The processing unit 202 of the information processing device 106 makes all of the air conditioners 110A to 110C that cool the container 100 start operation (operation S201). The processing unit 202 of the information processing device 106 performs the airtightness determination processing (1) to (7) in the state in which all of the air conditioners 110A to 110C are operating (test pattern A) (operation S202). The processing unit 202 of the information processing device 106 determines whether there is a problem with the airtightness of the container 100 or the air conditioners 110A to 110C (operation S203). When there is no problem with the airtightness of the container 100 or the air conditioners 110A to 110C (NO in operation S203), the processing unit 202 of the information processing device 106 ends the processing of identifying equipment having poor airtightness.

When there is a problem with the airtightness of the container 100 or the air conditioners 110A to 110C (YES in operation S203), the processing unit 202 selects one test pattern based on the information on the test patterns which is stored in the information processing device 106 (operation S204). The test pattern may for example be selected in order in which the test patterns are stored in the information processing device 106. The test pattern may be selected randomly from among the test patterns stored in the information processing device 106. According to the selected test pattern, the processing unit 202 makes one air conditioner 110 operate, and stops the operation of the other air conditioners 110 (operation S205). In operation S205, the processing unit 202 performs control processing that closes the ventilating holes 411 and the ventilating holes 412 of the stopped air conditioners 110. The processing unit 202 may close the ventilating holes 411 and the ventilating holes 412 by controlling shutters, for example. When a shutter of the air conditioner 110 to be made to operate is closed, the processing unit 202 performs control to open the shutter closing the ventilating holes 411 and 412 of the air conditioner 110 to be made to operate.

The processing unit 202 performs the airtightness determination processing (1) to (7) in the state in which one of all of the air conditioners 110A to 110C is operating (test pattern B) (operation S206). The processing unit 202 determines whether all of the test patterns stored in the information processing device 106 have been executed (operation S207). When not all of the test patterns have been executed (NO in operation S207), the processing unit 202 repeats the processing from operation S204.

When all of the test patterns have been executed (YES in operation S207), the processing unit 202 determines whether there is the air conditioner 110 having a problem with airtightness based on test results of the respective test patterns and the test result information (operation S208). When there is no air conditioner 110 having a problem with airtightness (NO in operation S208), the processing unit 202 determines whether there is a problem with the airtightness of the container 100 based on the test results of the respective test patterns and the test result information (operation S209). When there is no problem with the airtightness of the container 100 (NO in operation S209), the processing unit 202 ends the processing of identifying equipment having poor airtightness. When there is the air conditioner 110 having a problem with airtightness (YES in operation S208), the processing unit 202 determines whether the operation can be continued with the air conditioners 110 having no problem (operation S210). The determination in operation S210 may be made based on information indicating the number of the air conditioners 110 that are sufficient to continue the operation for the container 100. The information is stored in the information processing device 106 in advance. When it is determined that the operation can be continued with the air conditioners 110 having no problem (YES in operation S210), the processing unit 202 stops the air conditioner 110 having a problem with airtightness, and continues the operation of the container type data center 120 with the remaining air conditioners 110 (operation S211). When there is a problem with the airtightness of the container 100 (YES in operation S209), or when it is difficult to continue the operation with the remaining air conditioners 110 (NO in operation S210), the processing unit 202 notifies the administrator of a warning (operation S212). After the processing unit 202 ends the processing of operation S212 or operation S211, the processing unit 202 ends the processing of identifying equipment having poor airtightness. The information processing device 106 thus makes the air conditioners 110A to 110C operate one by one and determines airtightness in each of the test patterns. It is thereby determined that one or a part or all of the air conditioners 110A to 110C or the container 100 has a problem with airtightness.

The equipment such as the humidifier and the thermo-hygrometers is low in cost and easy to set. Therefore, in the container type data center 120, airtightness may be estimated easily by using the humidifier and the thermo-hygrometers. Whether there is a problem with the airtightness of an air conditioner may also be determined.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment of the present invention has been described in detail, it should be understood that the various changes, substitutions, and alterations could be made hereto without departing from the spirit and scope of the invention.

What is claimed is:

1. A container comprising:
a humidifier configured to humidify a room to a given humidity;
a measuring instrument configured to measure humidity of the room for a fixed time from a point in time that the room is humidified to the given humidity; and
an information processing device configured to obtain an opening area of the room based on an amount of decrease in absolute humidity in the fixed time.

2. The container according to claim 1,
wherein the opening area is obtained by using opening area information associating the amount of decrease in the absolute humidity with the opening area.

3. The container according to claim 1,
wherein the information processing device determines that airtightness is poor when the opening area is equal to or more than a given value.

4. The container according to claim 1, further comprising
a plurality of ventilating holes configured to take, into the room, air cooled by a plurality of air conditioners,
wherein a plurality of air passages between the plurality of air conditioners and the plurality of ventilating holes are opened and closed by a plurality of lids.

5. The container according to claim 4,
wherein the information processing device obtains the opening area in a state in which the plurality of lids are opened or closed, respectively.

6. The container according to claim 4,
wherein when the opening area obtained in a first state in which all of the plurality of lids are opened is larger than a given value, the information processing device obtains the opening area in a second state in which at least one of the plurality of lids is closed.

7. The container according to claim 1,
wherein the information processing device, when the opening area is larger than a given value, determines whether there is a problem with airtightness of at least one of a plurality of air conditioners that cool the room or airtightness of the room, based on the amount of decrease in the absolute humidity when the plurality of air conditioners are made to operate one by one.

8. The container according to claim 7,
wherein respective operations of the plurality of air conditioners are controlled by opening or closing respective lids provided between the plurality of air conditioners and a plurality of ventilating holes that take air cooled by the plurality of air conditioners into the room.

9. An evaluating method comprising:
measuring humidity of a room for a fixed time from a point in time that the room is humidified to a given humidity; and
calculating, by an information processing device, an opening area of the room based on an amount of decrease in absolute humidity in the fixed time, and evaluating airtightness.

10. A container type data center comprising:
a container; and
a plurality of air conditioners configured to feed cooled air into the container;
the container including:
a humidifier configured to humidify the container to a given humidity;
a measuring instrument configured to measure humidity within the container; and
an information processing device configured to obtain an opening area of the container based on an amount of decrease in absolute humidity of the container in a fixed time from a point in time that the container is humidified to the given humidity.

11. The container type data center according to claim 10,
wherein the information processing device calculates the absolute humidity based on relative humidity measured within the container and a temperature within the container.

12. The container type data center according to claim 10,
wherein the opening area is obtained by using opening area information associating the amount of decrease in the absolute humidity with the opening area.

13. The container type data center according to claim 10,
wherein the information processing device determines that airtightness is poor when the opening area is equal to or more than a given value.

14. The container type data center according to claim 10, further comprising
a plurality of ventilating holes configured to take, into the room, air cooled by the plurality of air conditioners,
wherein a plurality of air passages between the plurality of air conditioners and the plurality of ventilating holes are opened and closed by a plurality of lids.

15. The container type data center according to claim 14,
wherein the information processing device obtains the opening area in a state in which the plurality of lids are opened or closed, respectively.

16. The container type data center according to claim 14,
wherein when the opening area obtained in a first state in which all of the plurality of lids are opened is larger than a given value, the information processing device obtains the opening area in a second state in which at least one of the plurality of lids is closed.

17. The container type data center according to claim 10,
wherein the information processing device, when the opening area is larger than a given value, determines whether there is a problem with airtightness of at least one of a plurality of air conditioners that cool the room or airtightness of the room, based on the amount of decrease in the absolute humidity when the plurality of air conditioners are made to operate one by one.

18. The container type data center according to claim 17,
wherein respective operations of the plurality of air conditioners are controlled by opening or closing respective lids provided between the plurality of air conditioners and a plurality of ventilating holes that take air cooled by the plurality of air conditioners into the room.
